(19) United States
(12) Patent Application Publication
(10) Pub. No.: US 2023/0405811 A1
(43) Pub. Date: Dec. 21, 2023

(54) EXTENSIBLE HARDWARE ABSTRACTION LAYER FOR REAL-TIME ROBOTICS CONTROL FRAMEWORK

(71) Applicant: Intrinsic Innovation LLC, Mountain View, CA (US)

(72) Inventors: Gregory J. Prisament, East Palo Alto, CA (US); Michael Beardsworth, San Francisco, CA (US); Asa Kaplan, San Francisco, CA (US); Karsten Knese, San Jose, CA (US); Nicholas Julian Cox, Mountain View, CA (US)

(21) Appl. No.: 18/208,792

(22) Filed: Jun. 12, 2023

Related U.S. Application Data
(60) Provisional application No. 63/351,775, filed on Jun. 13, 2022.

(51) Int. Cl. B25J 9/16

(52) U.S. Cl. CPC B25J 9/161; B25J 9/1682; B25J 9/1656

(57) ABSTRACT

Methods, systems, and apparatus, including computer programs encoded on computer storage media, for controlling robots. One of the methods includes receiving custom hardware configuration data for a robot, wherein the custom hardware configuration data specifies a mapping between parts and interfaces belonging to software modules that each correspond to a respective robotic hardware element of the robot, wherein each software module has one or more interfaces that represent capabilities of a robot, and wherein each part, in real-time control code defining actions of a real-time control layer, can reference interfaces of multiple software modules; allocating shared memory resources according to the mapping between parts and interfaces defined in the custom hardware configuration data; executing each software module in a separate process of a real-time control system; and executing the real-time control code that references the interfaces using parts as defined in the custom hardware configuration data.

### CROSS-REFERENCE TO RELATED APPLICATIONS

This application claims priority to U.S. Provisional Application No. 63/351,775, filed on Jun. 13, 2022. The disclosure of the prior application is considered part of and is incorporated by reference in the disclosure of this application.

### BACKGROUND

This specification relates to frameworks for software control systems.

Real-time software control systems are software systems that must execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation. Such real-time software control systems are often used to control physical machines that have high precision and timing requirements. As one example, a workcell of industrial robots can be controlled by a real-time software control system that requires each robot to repeatedly receive commands at a certain frequency, e.g., 1, 10, or 100 kHz. If one of the robots does not receive a command during one of the periodic time windows, the robot can enter a fault state by halting its operation or by automatically executing a recovery procedure to return to a maintenance position. In this specification, a workcell is the physical environment in which a robot will operate. Workcells have particular physical properties, e.g., physical dimensions that impose constraints on how robots can move within the workcell.

Due to such timing requirements, software control systems for physical machines are often implemented by closed software modules that are configured specifically for highly-specialized tasks. For example, a robot that picks components for placement on a printed circuit board can be controlled by a closed software system that controls each of the low-level picking and placing actions.

### SUMMARY

This specification describes a real-time robotics control framework that provides a unified platform for achieving multiple new capabilities for custom real-time control. Specifically, the control framework described in this specification can provide real-time control guarantees over one or more physical robots, i.e., can execute one or more physical robots, including any associated sensors or end effectors, within strict timing requirements to achieve normal operation of the robotic system. In addition, the control framework described in this specification is extensible and customizable. The control framework can allow a user to swiftly and easily integrate an arbitrary piece of hardware, e.g., a new robot model, a new type of sensor, a proprietary end effector, or the like, into the robotics control framework, even if the piece of hardware is novel to and has never been executed within the robotics control framework.

In this specification, a framework is a software system that allows a user to provide higher level program definitions while implementing the lower level control functionality of a real-time robotics system. In this specification, the operating environment includes multiple subsystems, each of which can include one or more real-time robots, one or more computing devices having software or hardware modules that support the operation of the robots, or both. The framework provides mechanisms for bridging, communication, or coordination between the multiple systems, including forwarding control parameters from a robot application system, providing sensor measurements to a real-time robotic control system for use in computing the custom action, and receiving hardware control inputs computed for the custom action from the real-time robotic control system, all while maintaining the tight timing constraints of the real-time robot control system, i.e., within certain periodic time windows.

Particular embodiments of the subject matter described in this specification can be implemented so as to realize one or more of the following advantages.

Unlike many existing robotics application frameworks which dictate the interface of the devices and software modules, and do not allow users to customize the interfaces for a particular use case, much less a real-time, custom use case, the real-time robotics control framework disclosed in this specification allows users to compose custom software modules as well as to formulate the data interfaces of the software modules that facilitate custom action execution by one or more robots that fit their needs. A real-time control system is a software system that is required to perform actions within strict timing requirements in order to achieve normal operation.

The real-time robotics control framework, as disclosed in this specification, is not only hardware agnostic but is also user extensible to unseen robotic hardware. Under the design of the disclosed real-time robotics control framework, the custom software modules facilitate easy integration of an arbitrary piece of robotic hardware, e.g., a new robot, a new tool, or a new sensor, into the hard real-time system, while additionally allowing real-time control of the robotic hardware that incorporates both real-time sensor information and custom control logic. Using custom software modules can, in some cases, provide additional capabilities for the robot to react in a more natural and fluid way, which results in higher precision movements, shorter cycle times, and more reliability when completing a particular task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is an example illustration of a real-time hardware abstraction layer executing different software modules.

FIG. 3 is an illustration of an example real-time state machine of operations within a real-time control cycle of a real-time robotic control system.

FIG. 4 is a flowchart of an example process for receiving custom hardware configuration data for a robot.

FIG. 5 is a flowchart of an example process for executing one or more hardware modules of a hardware abstraction layer for controlling a robot.

Like reference numbers and designations in the various drawings indicate like elements.

### DETAILED DESCRIPTION

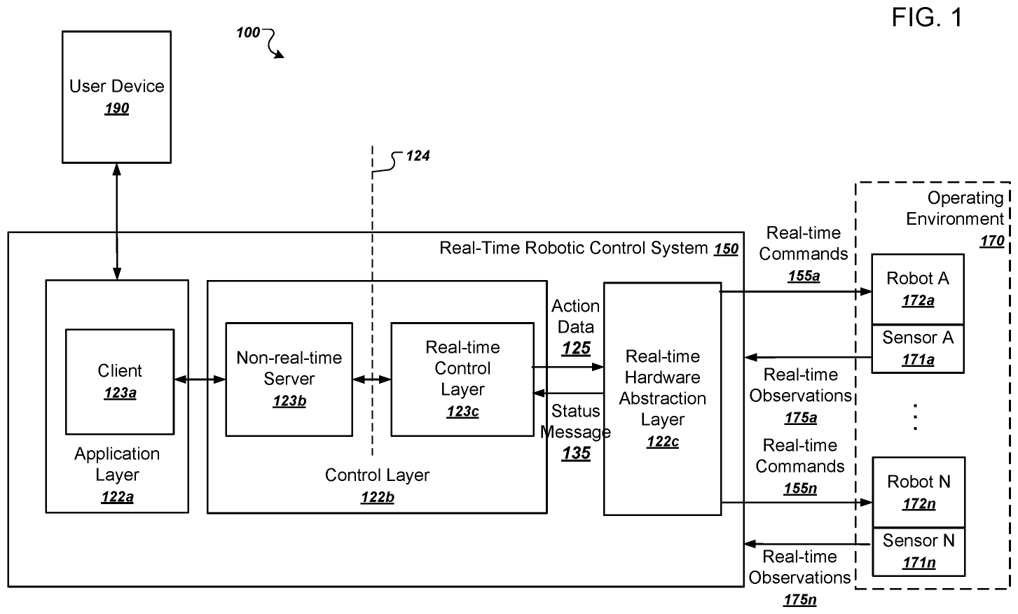

FIG. 1 is a diagram of an example system 100. The system 100 includes a real-time robotic control system 150 to drive multiple robots 172a-n in an operating environment 170. The system 100 includes a number of functional components that can each be implemented as computer programs installed on one or more computers in one or more locations that are coupled to each other through any appropriate communications network, e.g., an intranet or the Internet, or combination of networks.

The system 100 is an example of a system that can implement the real-time robotics control framework as described in this specification. In particular, the system 100 can provide a unified framework that allows users to achieve multiple different types of custom real-time control. In this specification, a robotic control system being described as being real-time means that it is required to execute within strict timing requirements to achieve normal operation. The timing requirements specify that certain actions must be executed or outputs must be generated within a particular time window in order for the system to avoid entering a fault state. For brevity, each time window may be referred to as a tick or a control tick. In the fault state, after a tick has elapsed without completing its required computations or actions, the system can halt execution or take some other action that interrupts normal operation, e.g., returning the robots to a starting pose or a fault pose.

Operations, e.g., processing steps for completing a task or function, in a non-real-time system are known as non-deterministic operations, which are not required to complete within a given tick to be successful. In contrast, a real-time system requires deterministic operations, which are required to occur every tick. In non-real-time and real-time systems, a scheduler may be utilized to determine the amount of resources, e.g., network bandwidth, memory, processor cycles, or a combination thereof, that an action is allotted for execution. If no or inadequate resources are allocated, the real-time system can also enter the fault state.

In this specification, real-time control being extensible and customizable means that a user can integrate an arbitrary piece of robotic hardware, e.g., a robot of an arbitrary make and/or model, into an operating environment by providing custom real-time control information that specifies how the robot should act or react at each tick of a real-time control cycle. In this specification, an action refers to a motion having precomputed motion parameters, such as moving a tool on a robot arm from point A to point B.

The real-time robotic control system 150 is configured to control the robots 172a-n in the operating environment 170 according to custom real-time control information. To control the robots 170a-n in the operating environment 170, the real-time robotic control system 150 provides commands, e.g., commands 155a-n, to be executed by one or more robots, e.g., robots 172a-n, in the operating environment 170. In order to compute the commands 155, the real-time robotic control system 150 consumes real-time observations 175a-n made by one or more sensors 171a-n gathering data within the operating environment 170. As illustrated in FIG. 1, each sensor 171 is coupled to a respective robot 172. However, the sensors need not have a one-to-one correspondence with robots and need not be coupled to the robots. In fact, each robot can have multiple sensors, and the sensors can be mounted on stationary or movable surfaces in the operating environment 170. Any suitable sensors 171 can be used, such as distance sensors, force sensors, torque sensors, cameras, to name just a few examples.

A powerful feature of the framework provided by the system 100 is that it can allow the users to specify such custom real-time control information with relatively small amounts of user code and simple configuration files. In some examples, the user code can be expressed in high-level programming languages, e.g., Object Oriented Programming (OOP) languages, including C++, Python, Lua, and Go; and the configuration file can be written as a metadata file, e.g., an XML (extensible mark-up language) file, a YAML file, or a JSON (JavaScript Object Notation) file. This capability for providing high-level, custom real-time control is vastly easier and more powerful than programming robot movements using only low-level commands that relate to joint angles or levels of electrical current.

A user of the system 100 can initiate the execution of custom real-time control by providing custom real-time control information to the real-time robotic control system 150. For example, a user can use a user device 190 to provide custom real-time control information to the application layer 122a. For example, through an integrated development environment (IDE) executed in the user device 190, the user can write code and create configuration files that are required to facilitate the real-time control of the one or more robots to perform a custom action.

It should be noted that, while the description in this specification largely relates to custom real-time control of robot itself, the system 100 and the described techniques can also provide custom real-time control of other suitable equipment associated with the robot. For example, the user can similarly provide custom real-time control information that specifies how a sensor or tool (or end effector) in the workcell should operate at each tick of a real-time control cycle, either in tandem with or independently of a robot. Example sensors include distance sensors, force sensors, torque sensors, cameras, and the like. Example tools include grippers, welding devices, gluing devices, sanding devices, and the like.

The real-time robotic control system 150 can then prepare the custom real-time control code for execution. Generally, the real-time robotic control system 150 can provide commands through a control stack 122 that handles providing real-time control commands 155a-n to the robots 172a-n. The control stack 122 can be implemented as a software stack that is at least partially hardware-agnostic. In other words, in some implementations the software stack can accept, as input, commands generated by the control system 150 without requiring the commands to relate specifically to a particular model of robot or to a particular robotic component.

The control stack 122 includes multiple levels, with each level having one or more corresponding software modules. In FIG. 1, the lowest level is the real-time hardware abstraction layer 122c which executes within strict real-time requirements, e.g., by providing a command at a first, fixed rate, e.g., every 5, 10, or 20 milliseconds, and the highest level is the application layer 122a which executes within non-real-time requirements, e.g., by providing a command at second, lower rate, which may sometimes be a varying rate or a rate that is sporadic, or both. Interposed between the non-real-time application layer 122a and the real-time hardware abstraction layer 122c is a control layer 122b, which handles bridging the boundary 124 between the non-real-time commands generated by upper-level software modules in the control stack 122 and the real-time commands generated by the lower-level software modules in the control stack 122. More details of the control stack 122 are described in commonly owned U.S. patent application Ser. No. 17/246,082, which is herein incorporated by reference.

The control layer 122b can include both a real-time control layer 123c and a non-real-time server 123b that collectively facilitate real-time control of a custom action from commands issued by the client 123a. The control layer 122b serves as a bridging module in the control stack that translates each non-real-time command into data that can be consumed by real-time controllers that are responsible for generating low-level real-time commands. Such low-level real-time commands can, for example, relate to the actual levels of electrical current to be applied to robot motors and actuators at each point in time in order to effectuate the movements specified by the command.

Upon being provided with the definition of the custom real-time action, the non-real-time server 123b in the control layer 122b can use this definition to initialize all the motion parameters for driving robots in the operating environment 170 and other state variables for real-time execution. For example, the non-real-time server 123b can preallocate memory and perform data format conversions between non-real-time data formats and real-time data formats. In the meantime, the real-time control layer 123c can use this definition to produce continuous real-time control signals including, e.g., real-time positions, velocities, or torques for a robot component such as a robot joint, which determine how to drive the motors and actuators of the robots 172a-n in order to effectuate the custom real-time action. The continuous real-time control signals can then be consumed by the hardware abstraction layer 122c.

The hardware abstraction layer 122c includes software modules that actually interface the robot 172a-n, e.g., by issuing real-time commands 155a-n to drive the movements of the moveable components such as joints of the robots 172a-n in the operating environment 170 to execute the custom real-time action. During execution of the custom real-time action, the hardware abstraction layer 122c provides an abstraction of the underlying hardware modules, e.g., a logical abstraction of the characteristics of the moveable components of the robots 172a-n, such that the complexity regarding the operations of the hardware modules are hidden from the upper-level software modules in the control stack 122, e.g., the software modules in the client 123a, the non-real-time server 123b, the real-time control layer 123c, or some combination of these.

In this specification, a “hardware module” refers to a separate piece of hardware, including the means for moving the piece of hardware, that has a specific task or function within the system 100 and is usually programmed or programmable by software or firmware or by a user establishing specific settings to achieve a specific task or function. For example, a hardware module can be a physical robotic hardware element, e.g., a moveable component such as a joint of a robot (including the means for moving the joint, e.g., an actuator or a motor), or can alternatively be a tool or a sensor that is used by the robot, or can further alternatively be a peripheral device in the operating environment 170, e.g., an Ethernet for Control Automation Technology (EtherCAT) enabled device, an Inter-Integrated Circuit (I2C) enabled device, or an Inter-IC Sound (I2S) enabled device.

In this specification, a “software module” refers to a separate unit of software programming code that has a specific task or function within the system 100. A software module may handle one step in a process or may handle a series of related steps required for completing a task or function. A software module may execute in a single process or threads, or may alternatively execute across multiple processes or threads. For example, a software module residing at the hardware abstraction layer 122c can include software programming code for controlling a hardware module, e.g., a moveable component such as a joint of a robot, within the operating environment 170 by issuing real-time commands to drive the movements of the hardware module to follow a target trajectory. The software module abstracts the real-time commands for the hardware module by manifesting characteristics and capabilities of the underlying hardware module.

In particular, by having one or more software modules that each correspond to a respective hardware module in the operation environment 170, the hardware abstraction layer 122c offers an abstraction that can represent or provide functionality that may be implemented by the hardware modules. Each software module corresponding to a distinct hardware module can execute in a separate process of the hardware abstraction layer 122c independently from one another.

In order to compute the real-time commands 155a-n for the robots 172a-n in the operating environment 170 to execute the custom real-time action, the hardware abstraction layer 122c consumes action data 125 provided by the real-time control layer 123c. The action data 125 can represent one or more actions to be performed by the robot within a real-time control cycle. The hardware abstraction layer 122c also consumes real-time observations 175a-n made by one or more sensors, e.g., sensors 171a-n, that are making observations within the operating environment 170. The hardware abstraction layer 122c reports status messages 135 generated as a result of the hardware modules performing operations to effectuate the action by the robot back to the real-time control layer 123c.

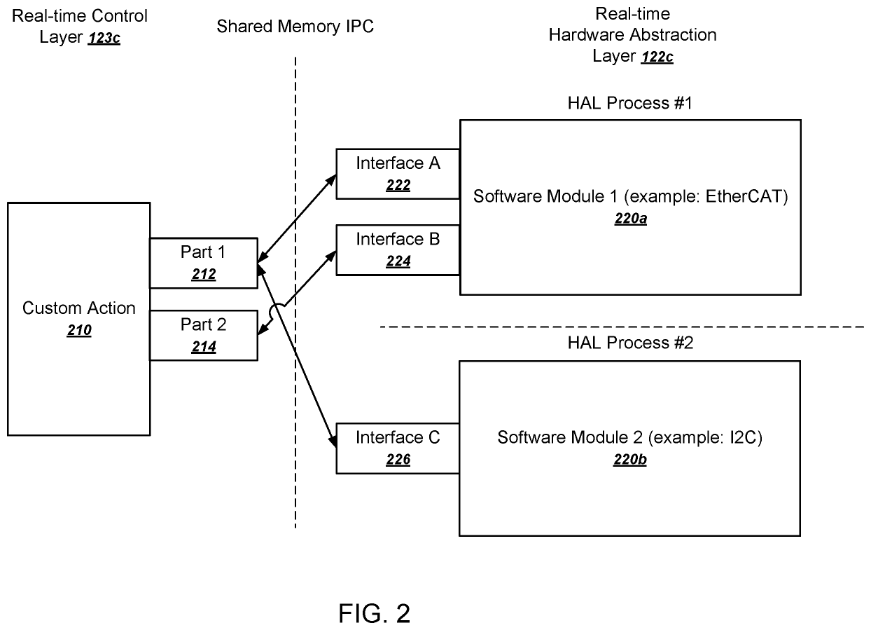

FIG. 2 is an example illustration of a real-time hardware abstraction layer executing different software modules.

For simplicity, FIG. 2 shows that two software modules 220a-b execute at the real-time hardware abstraction layer 122c, where the software modules implement different communication mechanisms. In this example, the software module 220a implements an EtherCAT enabled device, and software module 220b implements an I2C enabled device. In practice, however, there may be more software modules that correspond to additional hardware modules. Each software module can execute in a separate process of the real-time hardware abstraction layer 122c. Each software module can have one or more corresponding software interfaces that specifies the real-time data that the software module receives as input and provides as output.

FIG. 2 also shows the real-time control layer 123c implementing software modules for facilitating the real-time control of the robots to perform a custom action 210. For example, the software modules executing at the real-time control layer 123c can include real-time control code that defines the custom action, e.g., code that generates real-time motion parameters for the custom action 210; and can also include custom control logics, e.g., control logics that defines switch between the custom action 210 and another action due to certain specified conditions, which can include sensor data that is updated in real-time.

An advantage of the hardware abstraction layer 122c is to provide an expandable set of software modules for various hardware modules, including physical robotic hardware, tools, sensors, and peripheral devices, based on user code and/or configuration file. This makes it possible to achieve the extensibility and customizability advantage of the framework provided by the system 100.

In some examples, a first user may provide code that exposes the capabilities of the hardware modules as software interfaces, while a second user may provide custom code to generate the motion parameters and custom control logics. In these examples, the first and second users need not be a same user, and need not even belong to a same organization. In other words, the system can receive the custom real-time control information from different sources, e.g., from different developers or organizations. For example, the first user may be an equipment manufacturer of the robotic hardware, and the second user may be a third-party developer who develops custom actions for various technical use cases.

The software modules 220a-b that execute at the real-time hardware abstraction layer 122c includes software interfaces 222-226 to higher-level software modules, e.g., the real-time control code defining the custom action 210 that executes at the real-time control layer 123c, where the software interfaces 222-226 are configured to communicate real-time data with the higher-level software modules.

A software interface can correspond to a list of function calls (methods) that perform a set of robotic operations to effectuate the custom action 210 according to the capability of a hardware module represented by the software interface. Higher-level software modules interacts with the software modules 220a-b and eventually interacts with the underlying hardware modules by referring to the software interfaces in the software modules and calling the methods of the software interfaces. These methods and their arguments and results can be conveniently defined by a user, with no assumption about the underlying hardware or implementation.

For example, software module 220a can receive, through the software interfaces 222 and 224, data that represents a custom action 210 to be performed by the robot within a real-time control cycle from the software modules executing at the real-time control layer 123c. The software module 220a can provide, through the software interfaces 222-224, status messages generated as a result of the underlying hardware modules performing operations to effectuate the custom action 210 by the robot back to the software modules executing at the real-time control layer.

The real-time control code for the custom action 210 that executes at the real-time control layer 123c interacts with the software modules 220a-b by referring to parts. Each part has a group of software interfaces that specifies a conglomerate of real-time data that is made available to the real-time control code for the custom action 210.

In particular, the real-time robotic control system 150 allows a user to precisely define, i.e., in a configuration file, the grouping the software interfaces into parts that can be referenced by a custom action executing in the real-time control layer 123c. The configuration file may group different software interfaces into one or more parts, where each part can include respective software interfaces of the same or different software modules. The configuration file may also include definitions of low-level protocols and payloads between the hardware abstraction layer 122c and the real-time control layer 123c. In some cases, the configuration file may define a common communications protocol between parts and interfaces, and where multiple interfaces use different communications protocols with lower-level devices to effectuate received commands. As such, a user is able to integrate an arbitrary piece of hardware, e.g., a new robot model, a new type of sensor, a proprietary end effector, or the like, into the real-time robotic control system 150, even if the piece of hardware is novel to and has never been executed within the system 150.

In the example of FIG. 2, the system 150 receives a configuration file. The configuration file can be generated by a user. In the configuration file the user specifies that a first part 212 includes software interface A 222 of software module 220a and software interface C 226 of software module 220b, which correspond to an EtherCAT device and an I2C device, respectively. The user also specifies that a second part 214 includes software interface B 224 of software module 220a. For example, the user may specify the grouping of different software interfaces based on common capabilities of various hardware modules represented by these software interfaces, common types of real-time data provided as output by these software interfaces, or the like.

The real-time robotic control system 150 uses the configuration file to configure the system to execute a custom real-time action. The system 150 can use the configuration file to map different interfaces of different software modules to the custom action by part names, thereby providing a location where the custom action can go to retrieve the real-time data that it needs for execution. The system 150 can implement the communications protocols according to the definitions in the configuration file. The system 150 can also establish one or more control channels according to the mapping between parts and interfaces defined in the custom hardware configuration data. The control channel is used to pass information between these components. For example, a control channel is established between the real-time control code for the custom action 210, on the one hand, and interface C 226 of software module 220b, on the other hand. In some implementations, to establish the control channel, the system 150 allocates shared memory resources to the real-time control layer and hardware abstraction layer. The shared memory resources includes the same memory segment(s) that both layers have access. In these implementations, the control channel can be implemented as interprocess communication (IPC) through the shared memory segments.

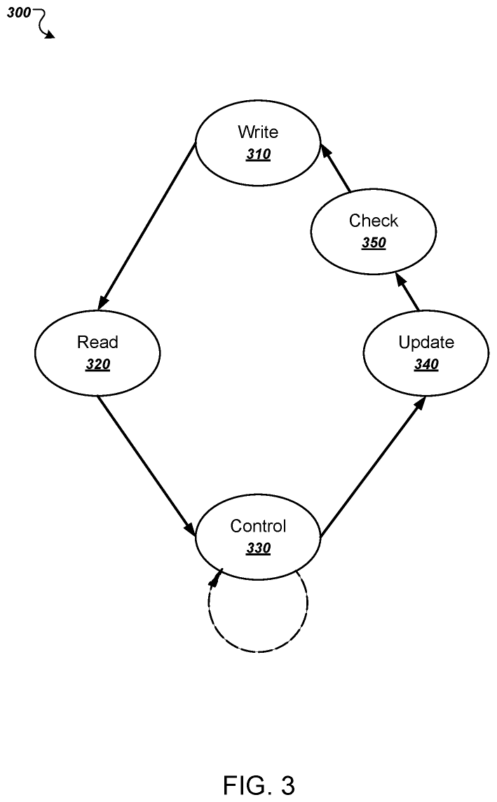

FIG. 3 is an illustration of an example real-time state machine 300 of operations within a real-time control cycle of a real-time robotic control system.

The example real-time state machine 300 illustrates how the disclosed real-time control system coordinates accesses to the shared memory between the real-time control layer and the hardware abstraction layer. In particular, the real-time robotic control system synchronizes accesses to the shared memory so that the software modules executing at the hardware abstraction layer performs a read operation only after a write operation performed by the custom real-time control code and guarantees that an update is provided by the hardware abstraction layer at every real-time control cycle, as will be described below.

The real-time control cycle of the hardware abstraction layer includes a write operation 310, a read operation 320, one or more control operations 330, an update operation 340, and a check operation 350, which execute repeatedly in a predetermined sequence in order to perform custom real-time control of a robot in an operating environment. Each of the operations 310, 320, 330, 340, and 350 executes within one or more predetermined time windows (ticks) in the real-time control cycle.

The example real-time state machine 300 illustrated in FIG. 3 begins with a write operation 310 performed by custom real-time control code executing at the real-time control layer. While executing the custom real-time control code, the real-time control layer can write to the shared memory data that represents an action to be performed by the robot within the real-time control cycle. In some implementation, the data written into the shared memory includes real-time messages are only available in a small time window during the real-time control cycle.

Following the write operation 310 is a read operation 320 performed by a software module executing at the hardware abstraction layer. By performing the read operation at a subsequent tick after the data has been written into the shared memory, the software module executing at the hardware abstraction layer can read, from the shared memory that is shared with the real-time control layer, the data that represents the action to be performed by the robot. The software module can additionally read updated sensor data, either from the shared memory or from another memory segment. The read data can then be used by the software module to control the one or more robots.

Next, the software module executing at the hardware abstraction layer performs one or more control operations 330, i.e., at one or more ticks of the real-time control cycle, to effectuate the action, e.g., by issuing real-time commands to drive the movements of the moveable components such as joints of the robot in the operating environment.

At a subsequent tick after the action has been effectuated, the software module performs an update operation 340 to update the status message in the shared memory. In this way the software module reports the status message generated as a result of the corresponding hardware module performing operations to effectuate the action by the robot back to the real-time control layer. To update the status message, the software module can write a new status message into the shared memory, optionally overwriting the existing status message in the shared memory.

In general, at every real-time control cycle, the real-time control layer performs a check operation 350 to check for the existence of an updated status message in the shared memory. For example, the real-time control layer can do this at the last tick of every real-time control cycle.

If an updated status message exists in the shared memory, i.e., if the status message was updated within the real-time control cycle, the real-time control layer proceeds to perform the next control cycle for the current action, or alternatively transitions to the real-time control cycle for a next action, according to the user's custom real-time control code. In either case, the real-time control system can re-perform the real-time control cycle (return to write operation 310).

If an updated status message does not exist in the shared memory, i.e., if the status message was not updated within the real-time control cycle, the real-time control layer directs the robot to perform a recovery operation. In some implementations, the recovery operation can include halting the operation of the robot or automatic execution of a recovery procedure to return to a maintenance position. In some implementations, the real-time control layer can do this by restarting one or more of the software modules in a new process.

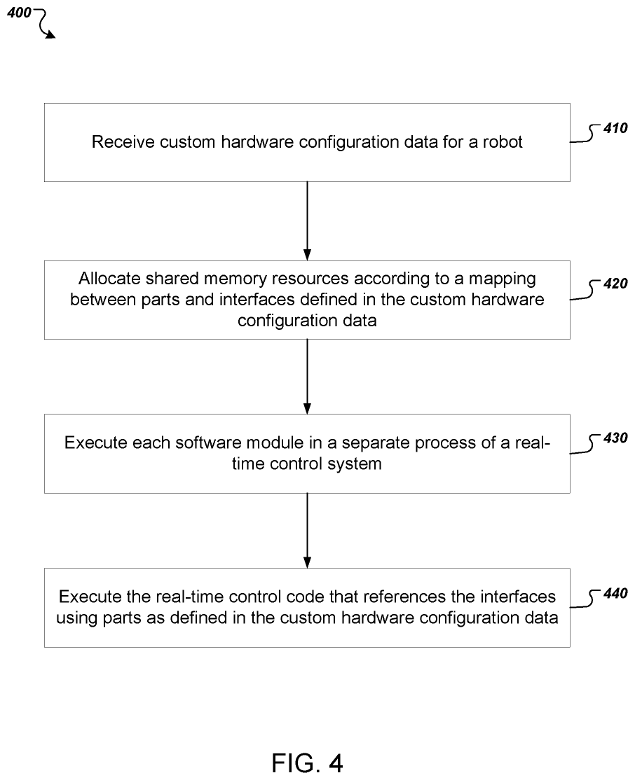

FIG. 4 is a flowchart of an example process 400 for receiving custom hardware configuration data for a robot. The process 400 can be implemented by one or more computer programs installed on one or more computers and programmed in accordance with this specification. For example, the process 400 can be performed by the real-time robotic control system 150 shown in FIG. 1. For convenience, the process 400 will be described as being performed by a system of one or more computers.

As described above, the system runs a real-time robotics control framework that is composed of a control stack of multiple levels of software modules, including a hardware abstraction layer which executes within strict real-time requirements, and a real-time control layer which generates continuous real-time control signals can then be consumed by the hardware abstraction layer.

The system receives custom hardware configuration data for one or more robots (410). The custom hardware configuration data can be a configuration file that is generated by a first user. The system also receives custom real-time control code that is provided by a second user. The custom real-time control code can include user code defining, e.g., class, object, or method instances, that are required to facilitate the real-time control of the one or more robots to perform a custom action.

The hardware abstraction layer includes software modules that interface one or more robots, e.g., by issuing real-time commands to drive the movements of the moveable components such as joints of the robots in an operating environment to execute the custom real-time action. Each software module can correspond to a respective robotic hardware element of a robot. Each software module can have one or more interfaces that represent capabilities of the robot.

The configuration file can specify a mapping between parts and interfaces belonging to software modules that execute at the real-time hardware abstraction layer. In the custom real-time control code defining custom actions of the real-time control layer, each part can reference interfaces of multiple software modules.

The mapping between the parts and the interfaces belonging to the software modules may include one-to-one, one-to-many, many-to-one, or many-to-many mappings between these components, depending on the data needs of the custom real-time action. In some implementations, the mapping between parts and interfaces may specify that a first part references interfaces in different respective software modules. In some implementations, the mapping between parts and interfaces may specify that a first interface can receive commands from different respective parts.

The custom hardware configuration data and the custom real-time control code may be provided by different users belonging to different organizations. For example, the first user may be an equipment manufacturer of the robotic hardware, and the second user may be a third-party developer who develops custom actions for various technical use cases.

The custom hardware configuration data, the custom real-time control code, or both can be at least partially hardware agnostic. In other words, in some implementations the system can accept custom hardware configuration data or custom real-time control code without requiring the configuration data or user code to relate specifically to a particular model of robot or to a particular piece of robotic hardware. For example, the same custom hardware configuration data may reference software module implementations for different models of robots. As another example, the real-time control code of the real-time control layer may be operable to cause the different models of robots to perform a same task.

The system can then use the custom hardware configuration data to configure the system to execute the custom real-time action. Specifically, the system establishes one or more control channels according to the mapping between parts and interfaces defined in the custom hardware configuration data. The control channel is used to pass information between these components.

In some implementations, to establish the control channel, the system allocates shared memory resources according to the mapping between parts and interfaces (420). The shared memory resources includes the same memory segment(s) that both layers have access. In these implementations, the control channel can be implemented using interprocess communication (IPC) through the shared memory segments.

In some implementations, the real-time robotics control framework implements a common communications protocol between parts and interfaces, and where multiple interfaces use different communications protocols with lower-level devices to effectuate received commands.

The system executes each software module in a separate process of the hardware abstraction layer relative to another software module (430). Thus there is a lower risk of manipulating the executions of these software modules, which correspond respectively to a robotic hardware element of a robot. Results of executing each hardware module, among other real-time messages, can be stored in the shared memory resources for retrieval by other hardware modules.

The system executes the custom real-time control code that references the interfaces (440) to implement the real-time control of the one or more robots to perform the custom action. Specifically, the custom real-time control code can reference an interface of a software module executing at the hardware abstraction layer by use of part names.

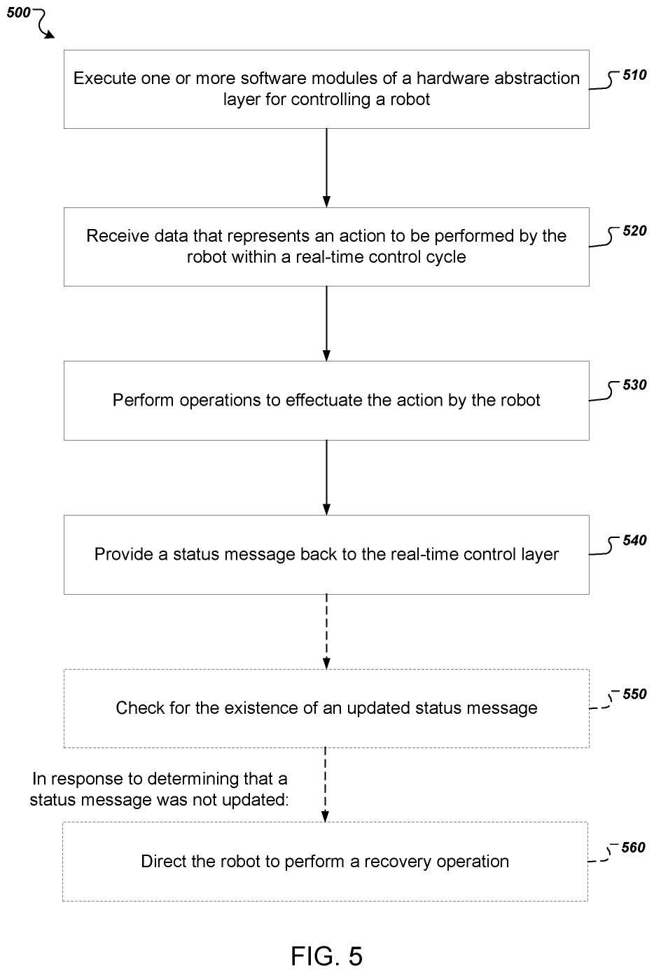

FIG. 5 is a flowchart of an example process 500 for executing one or more hardware modules of a hardware abstraction layer for controlling a robot. The process 500 can be implemented by one or more computer programs installed on one or more computers and programmed in accordance with this specification. For example, the process 500 can be performed by the real-time robotic control system 150 shown in FIG. 1. For convenience, the process 500 will be described as being performed by a system of one or more computers.

As described above, the system runs a real-time robotics control framework that is composed of a control stack of multiple levels of software modules, including a hardware abstraction layer which executes within strict real-time requirements, and a real-time control layer which generates continuous real-time control signals can then be consumed by the hardware abstraction layer.

The system executes each of one or more software modules at the hardware abstraction layer for controlling one or more robots (510) in a separate process of the layer relative to another software module. Each software module can correspond to a respective robotic hardware element of the robot. Each software module can have a plurality of interfaces that represent capabilities of a robot and that can be called by other software components of the system, e.g., by the custom real-time control code that resides at the real-time control layer. For examples, the interfaces can expose callable software functions that can be invoked by the custom real-time control code.

The system executes custom real-time control code at the real-time control layer. The custom real-time control code can reference the interfaces in the hardware abstraction layer by use of part names, where each part includes one or more software modules that each correspond to a respective robotic hardware element of the robot. In some implementations, a part can expose multiple interfaces to different software modules.

The system receives, by a software module of the hardware abstraction layer, data that represents an action to be performed by the robot within a real-time control cycle (520). The data can include data that has been written to the shared memory by the real-time control layer during execution of the custom real-time control code. Thus, receiving the data that represents the action to be performed can include reading the data from shared memory that is shared with the real-time control layer.

The system performs, by the software module, operations to effectuate the action by the robot (530). In some implementations, this can include using the software module that resides at the hardware abstraction layer to issue real-time commands to drive the movements of the moveable components such as joints of the robot in the operating environment.

The system provides, by the software module, a status message back to the real-time control layer (540). To provide the status message, the software module can write a new status message into the shared memory, optionally overwriting the existing status message in the shared memory.

Optionally, in some implementations, the system checks, by the real-time control layer, for the existence of an updated status message in the shared memory (550).

In response to determining that a status message was not updated, the system directs the robot to perform a recovery operation (560). In some implementations, the recovery operation can include halting the operation of the robot or automatic execution of a recovery procedure to return to a maintenance position. In some implementations, the real-time control layer can do this by restarting one or more of the software modules in a new process.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an operating environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A computer-implemented method comprising:
receiving, by a real-time robotics control framework, custom hardware configuration data for a robot, wherein the custom hardware configuration data specifies a mapping between parts and interfaces belonging to software modules that each correspond to a respective robotic hardware element of the robot, wherein each software module has one or more interfaces that represent capabilities of a robot, and wherein each part, in real-time control code defining actions of a real-time control layer, can reference interfaces of multiple software modules;
allocating shared memory resources according to the mapping between parts and interfaces defined in the custom hardware configuration data;
executing each software module in a separate process of a real-time control system; and
executing the real-time control code that references the interfaces using parts as defined in the custom hardware configuration data.

2. The method of claim 1, wherein the custom hardware configuration data is hardware agnostic.

3. The method of claim 2, wherein the same custom hardware configuration data references software module implementations for different models of robots.

4. The method of claim 2, wherein the real-time control code of the real-time control layer is operable to cause the different models of robots to perform a same task.

5. The method of claim 1, wherein the mapping between parts and interfaces specifies that a first part references interfaces in different respective software modules.

6. The method of claim 1, wherein the mapping between parts and interfaces specifies that a first interface can receive commands from different respective parts.

7. The method of claim 1, wherein the real-time robotics control framework implements a common communications protocol between parts and interfaces, and wherein multiple interfaces use different communications protocols with lower-level devices to effectuate received commands.

8. A system comprising one or more computers and one or more storage devices storing instructions that are operable, when executed by the one or more computers, to cause the one or more computers to perform operations comprising:
receiving, by a real-time robotics control framework, custom hardware configuration data for a robot, wherein the custom hardware configuration data specifies a mapping between parts and interfaces belonging to software modules that each correspond to a respective robotic hardware element of the robot, wherein each software module has one or more interfaces that represent capabilities of a robot, and wherein each part, in real-time control code defining actions of a real-time control layer, can reference interfaces of multiple software modules;
allocating shared memory resources according to the mapping between parts and interfaces defined in the custom hardware configuration data;
executing each software module in a separate process of a real-time control system; and
executing the real-time control code that references the interfaces using parts as defined in the custom hardware configuration data

9. The system of claim 8, wherein the custom hardware configuration data is hardware agnostic.

10. The system of claim 9, wherein the same custom hardware configuration data references software module implementations for different models of robots.

11. The system of claim 9, wherein the real-time control code of the real-time control layer is operable to cause the different models of robots to perform a same task.

12. The system of claim 8, wherein the mapping between parts and interfaces specifies that a first part references interfaces in different respective software modules.

13. The system of claim 8, wherein the mapping between parts and interfaces specifies that a first interface can receive commands from different respective parts.

14. The system of claim 8, wherein the real-time robotics control framework implements a common communications protocol between parts and interfaces, and wherein multiple interfaces use different communications protocols with lower-level devices to effectuate received commands.

15. A computer-implemented method comprising:
executing one or more software modules of a hardware abstraction layer for controlling a robot, wherein each software module corresponds to a respective robotic hardware element of the robot and executes in a separate process of a real-time control system for the robot;
receiving, by a software module of the hardware abstraction layer from a real-time control layer, data that represents an action to be performed by the robot within a real-time control cycle;
performing, by the software module, operations to effectuate the action by the robot; and
providing, by the software module, a status message back to the real-time control layer.

16. The method of claim 15, wherein the software module has a plurality of interfaces that represent capabilities of the robot.

17. The method of claim 16, wherein control code implementing at the real-time control layer references the interfaces in the hardware abstraction layer according to parts, wherein each part includes one or more software modules that each correspond to a respective robotic hardware element of the robot.

18. The method of claim 16, wherein a first part exposes multiple interfaces to different software modules.

19. The method of claim 16, wherein receiving the data that represents the action to be performed comprises reading the data from shared memory that is shared with the real-time control layer.

20. The method of claim 19, wherein providing the status message back to the real-time control layer comprises writing to the shared memory.
